(19) United States
(12) Patent Application Publication
(10) Pub. No.: US 2009/0003733 A1
(43) Pub. Date: Jan. 1, 2009

(54) ELECTRONIC WRITING INSTRUMENT, CAP, COMPUTER SYSTEM AND ELECTRONIC WRITING METHOD

(75) Inventors: Eisuke OSAKABE, Ashigarakami-gun (JP); Tomohito TAKAGI, Yokohama-shi (JP); Shin TAKEUCHI, Ashigarakami-gun (JP); Eigo NAKAGAWA, Ashigarakami-gun (JP); Hiroyuki FUNO, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 12/017,419

(22) Filed: Jan. 22, 2008

(30) Foreign Application Priority Data
Jun. 27, 2007 (JP) 2007-169711

(51) Int. Cl. G06K 9/22

(52) U.S. Cl. 382/314

(57) ABSTRACT

An electronic writing instrument is provided with: an electronic writing instrument body portion that captures a code image formed on a medium based on reflected light; and a detachable cap that is attached to the one end side of the electronic writing instrument body portion. The electronic writing instrument body portion has: at one end side thereof, a writing unit that writes down on the medium on which the code image is formed; a light emitting unit that emits light to the medium; and an image capture unit that captures an image from reflected light reflected on the medium by the emitting light. The detachable cap is configured so as to cover the writing unit when attached to the one end side, and to pass emitted light from the light emitting unit and the reflected light from the medium.

### CROSS REFERENCE TO RELATED APPLICATIONS

This application is based on and claims priority under 35 USC §119 from Japanese Patent Application No. 2007-169711 filed Jun. 27, 2007.

### BACKGROUND

1. Technical Field

The present invention relates to an electronic writing instrument, a cap, a computer system and an electronic writing method.

2. Related Art

In recent years, a pen-type input apparatus is attracting attention, for example, as an input apparatus for computer apparatus. This kind of pen-type input apparatus is provided with, in addition to the recording function as a so-called pen for writing down on a medium, a read function to read an image formed on a medium.

### SUMMARY

According to an aspect of the invention, there is provided an electronic writing instrument including: an electronic writing instrument body portion that captures a code image formed on a medium based on reflected light, the electronic writing instrument body portion having: at one end side thereof, a writing unit that writes down on the medium on which the code image is formed; a light emitting unit that emits light to the medium; and an image capture unit that captures an image from reflected light reflected on the medium by the emitting light; and a detachable cap that is attached to the one end side of the electronic writing instrument body portion and is configured so as to cover the writing unit when attached to the one end side, and to pass emitted light from the light emitting unit and the reflected light from the medium.

### BRIEF DESCRIPTION OF THE DRAWINGS

Exemplary embodiment (s) of the present invention will be described in detail based on the following figures, wherein:

FIG. 1 shows an example of a configuration of a writing information processing system to which the first exemplary embodiment is applied;

FIGS. 2A to 2C are diagrams for explaining the code pattern images;

FIGS. 3 and 4 are perspective views showing a configuration of the digital pen;

FIG. 5 shows a configuration of the inside of the electronic writing instrument body portion;

FIGS. 6A to 6C are diagrams for explaining the detailed configuration of the light emitting unit and the image capture unit provided in the electronic writing instrument body portion;

FIGS. 7A to 7C are diagrams for explaining a detail configuration of the cap;

FIGS. 8A and 8B show the light transmission characteristics of the cover provided in the cap;

FIG. 9 shows a form of a carte sheet as an example of the printed material;

FIGS. 10A and 10B are diagrams for explaining how to capture the code image in the first mode, that is, in the writing mode;

FIGS. 11A and 11B are diagrams for explaining how to capture a code image in the second mode, that is, in the reference information acquiring mode;

FIGS. 12A to 12C are diagrams for explaining a detailed configuration of the cap used for the digital pen according to the second exemplary embodiment;

FIGS. 13A and 13B are diagrams for explaining the capturing of the code image in the reference information acquiring mode;

FIGS. 14A to 14C are diagrams for explaining the detailed configuration of the cap used for the digital pen according to the third exemplary embodiment; and

FIGS. 15A and 15B are diagrams for explaining the capturing of the code image in the reference information acquiring mode.

### DETAILED DESCRIPTION

Hereinafter, exemplary embodiments of the present invention will be described in detail with reference to the attached drawings.

### First Exemplary Embodiment

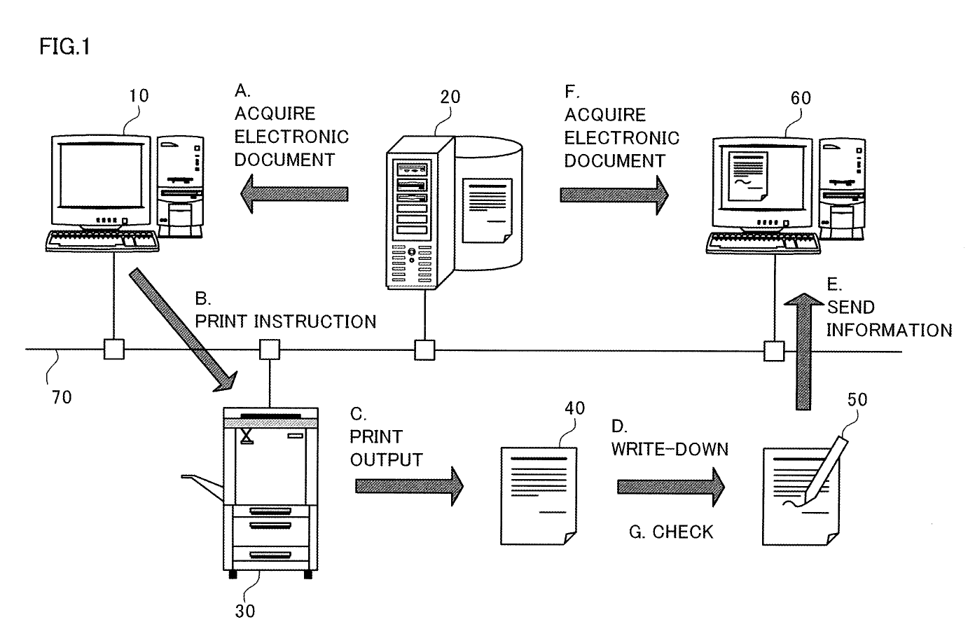

FIG. 1 shows an example of a configuration of a writing information processing system to which the first exemplary embodiment is applied. The writing information processing system according to the first exemplary embodiment is configured to include a terminal apparatus 10 that instructs to print an electronic document, a document server 20 that stores the electronic document, and the image forming apparatus 30 that prints an image in which a code pattern image is superimposed on an electronic document image.

The writing information processing system according to the first exemplary embodiment further includes a printed material 40 as an example of a medium that is outputted by the image forming apparatus 30, a digital pen 50 that writes a character or a figure onto the printed material 40 and also captures the code pattern to trace the character or the figure written on the printed material 40, and a terminal apparatus 60 as an example of an information processing apparatus that displays the trace received from the digital pen 50 superimposed on an electronic document received from the document server 20.

In addition, in the writing information processing system according to the first exemplary embodiment, the terminal apparatus 10, the document server 20, the image forming apparatus 30 and the terminal apparatus 60 are interconnected via a network 70 with each other. The digital pen 50 is connected with the terminal apparatus 60 via a wireless network (not shown in the figure).

An operation of the writing information processing system according to the first exemplary embodiment is outlined below.

First, the terminal apparatus 10 acquires an electronic document that is to be printed, from the document server 20(A). Then, the terminal apparatus 10 instructs the image forming apparatus 30 to print the electronic document (B). At this time, the terminal apparatus 10 specifies a print attribute which is a parameter concerning the printing. This print attribute includes a sheet size, a direction, both-side printing and the like, similarly to the case in the normal printing. With respect to the code image, that is, a code pattern image, a position on which the code pattern image should be printed may be included in the print attribute.

When receiving an instruction to print the electronic document, the image forming apparatus 30 outputs the printed material 40 as a paper or the like on which the code pattern image superimposed on an electronic document image is printed (C). In this case, the code pattern image is an image generated from both an identity code corresponding to the identity information and a location code corresponding to the information of the location on the document. Alternatively, the code pattern image may be an image generated from them and additional information as other information. The processing of superimposing the code pattern image on the electronic document image may be carried out in the terminal apparatus 10 or in the image forming apparatus 30.

Here, as the identity information, information that uniquely identifies each medium is adopted. For example, it may be information acquired by combining an identity number of the image forming apparatus 30 with a serial number for printing the medium in the image forming apparatus 30 or printing date and time, or information centrally managed so that no duplication occurs on a predetermined server. Alternatively, as the identity information, information that does not uniquely identifies each medium but that uniquely identifies an electronic document printed on the medium may be adopted.

The location information indicates information for specifying a coordinate location (X-coordinate, Y-coordinate) on each medium. For example, the coordinates may be represented with a coordinate system in which the origin is set as the left top point of the medium, X-axis is set as the right direction of the medium and Y-axis is set as the downward direction.

Further, the additional information may include identity information of a user who instructs to print and information of copy prohibition.

The image forming apparatus 30 forms a code pattern image as an invisible image using invisible toner, which has absorptance of near-infrared light of a certain level or higher. On the other hand, a document image of the electronic document is preferably formed as a visible image using visible toner with an infrared light absorption rate of a certain level or lower. The difference in the absorptance of infrared light is set between toner for the code pattern image and toner used to form a document image so that the capturing precision at the capturing of the code pattern image by infrared light emitting by the digital pen 50 or the like is secured. In the first exemplary embodiment, a description will be given with the capturing of a code pattern image by infrared light emitting as a premise. However, the capturing of the code pattern image by ultraviolet light emitting may be also allowed using a material that has low absorptance of ultraviolet light to compose code pattern.

Assume a case where a user thereafter uses the digital pen 50 to write characters or figures onto the printed material 40(D). When the user uses the digital pen 50 to write a character or a figure on the printed material 40, the digital pen 50 is set to a writing mode as later mentioned. At this time, the digital pen 50 performs a writing operation on the printed material 40 and emits an infrared light on the printed material 40 at the same time, and an infrared image is inputted to the digital pen 50 by detecting reflected light thereof. Then, the digital pen 50 acquires writing information from the infrared image and, via wireless communication, sends the information to the terminal apparatus 60(E). The writing information sent here includes, for example, the identity information for the printed material 40, and the location information of the written character or figure on the printed material 40.

Then, the terminal apparatus 60, based on the identity information received from the digital pen 50, acquires an electronic document which is a source of the document image printed on the printed material 40 from the document server 20(F). Then, the terminal apparatus 60 displays the information acquired from the digital pen 50 superimposed on the electronic document acquired from the document server 20.

Assume a case where a user checks a specific area of the printed material 40 using the digital pen 50(G). When a digital pen 50 is used to check the specific area of the printed material 40, it is set to the reference information acquiring mode later mentioned. At this time, the digital pen 50, similarly to the case of the writing mode, emits an infrared light on the printed material 40, and an infrared image is inputted to the digital pen 50 by detecting the reflected light thereof. The digital pen 50 acquires reference information from the infrared image, and, via the wireless communication, sends the information to the terminal apparatus 60(E). The reference information sent here includes, for example, the identity information for the printed material 40 and the location information at a specific area checked out of the printed material 40.

Then, the terminal apparatus 60, based on the identity information and the location information received from the digital pen 50, acquires an electronic document corresponding to the identity information and the location information, from the document server 20(F). Then, the terminal apparatus 60 displays the electronic document acquired from the document server 20.

Here, when the identity information received from the digital pen 50 is the information that uniquely identifies each medium, in order to acquire an electronic document based on the identity information, it is necessary to manage relationship between the identity information and the electronic document. In the writing information processing system shown in FIG. 1, any portion may manage the relationship as far as it is accessible from the terminal apparatus 60. For example, it may be the document server 20 or the image forming apparatus 30. If the identity information received from the digital pen 50 uniquely identifies an electronic document printed on the medium, the electronic document may be acquired without referencing such the correspondence relationship.

In the writing mode, if the terminal apparatus 60 receives trace information from the digital pen 50, the trace information is displayed so that the trace information is superimposed on the location of the electronic document corresponding to the writing location on the printed material 40. Since the location information on the writing operation is included in the code pattern image captured by the digital pen 50, the location information specifies the corresponding location on the display image of the electronic document.

On the other hand, in the reference information acquiring mode, in order for the terminal apparatus 60 to acquire an electronic document based on the identity information and the location information received from the digital pen 50, the relationship of the identity information and the location information with electronic document should be managed. In the writing information processing system shown in FIG. 1, any portion may manage it as far as it is accessible from the terminal apparatus 60. For example, it may be the document server 20 or the image forming apparatus 30.

Here, the writing mode, as an example of the first mode, is an operation mode in which the writing information such as characters and figures written down on a printed material 40 by using the digital pen 50 is acquired by the digital pen 50. Here, the writing information includes, as mentioned above, for example, the identity information of the printed material 40 and the location information of the written characters or figures on the printed material 40.

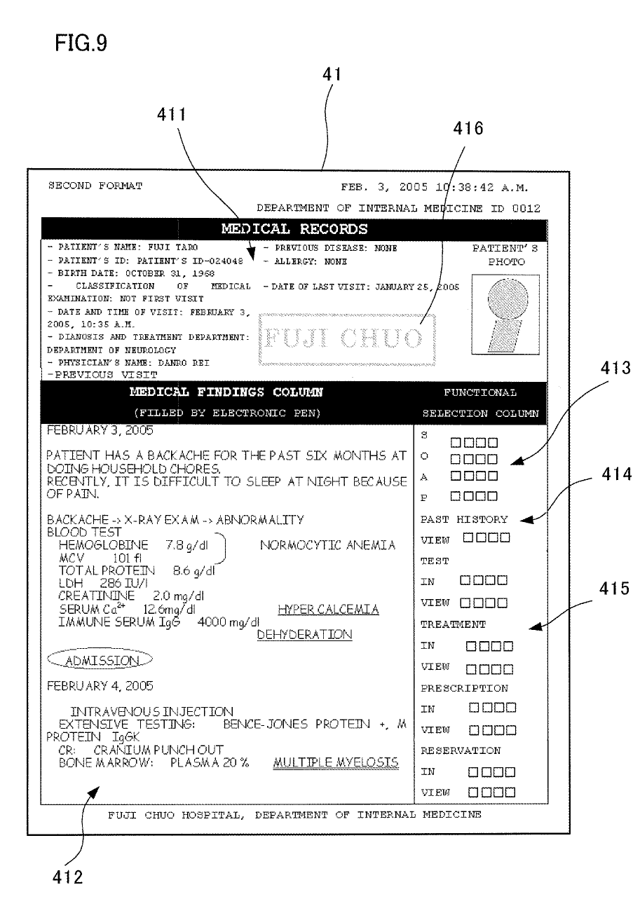

The reference information acquiring mode, as an example of the second mode, is an operation mode in which the reference information is acquired by the digital pen 50 by indicating with the digital pen 50 such as the entry type selection field 413 (refer to FIG. 9) of the carte sheet 41 as an example of the printed material 40 as later described. Here, the reference information includes, as above mentioned, for example, the identity information of the printed material 40 and the location information in a specific area that is checked within the printed material 40.

In an example shown in FIG. 1, in the writing mode or the reference information acquiring mode, the writing information or the reference information acquired by the digital pen 50 is sent to the terminal apparatus 60. However, in the writing mode or the reference information acquiring mode, it is sufficient that a desired writing information or the reference information is acquired, and the acquired writing information or reference information may be stored in a memory (not shown in the figure) prepared in, for example, the digital pen 50.

The above mentioned configuration of the writing information processing system to which the first exemplary embodiment is applied is only an example. For example, processing for superimposing the code pattern image on the electronic document image is configured so as to be performed by a device such as a server computer that relays the print instruction from the terminal apparatus 10 to the image forming apparatus 30. The document server 20 maybe installed in the terminal apparatus 10. Further, the terminal apparatus 10 and the terminal apparatus 60 may be configured in the same terminal apparatus.

In the first exemplary embodiment, the term “electronic document” is used. However, it does not only indicate electronic data of a document including a text. For example, the “electronic document” includes image data (not depending on raster data or vector data) such as pictures, photographs, figures and the like, and other electronic data used for printing.

Next, code pattern images printed by the image forming apparatus 30 are described below.

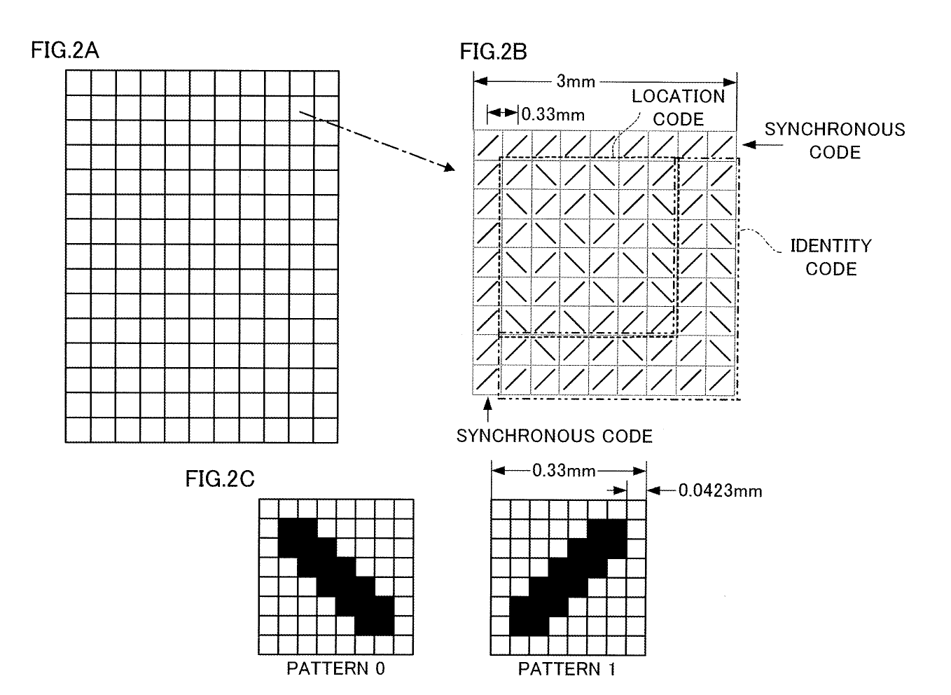

FIGS. 2A to 2C are diagrams for explaining the above mentioned code pattern images. FIG. 2A schematically shows a two-dimensional code arrangement formed as an invisible image. FIG. 2B shows an expanded diagram of the two-dimensional code, which is a unit of the two-dimensional code arrangement shown in FIG. 2A. Further, FIG. 2C is a diagram for explaining pattern images of a backslash “\” and a slash “/.”

In the first exemplary embodiment, the code pattern images shown in FIGS. 2A to 2C are formed by using an invisible image forming material having an absorption in a near-infrared region. The code pattern images shown in FIGS. 2A to 2C are formed by transparent toner having, for example, the maximum absorptance of not more than seven (7) percents in the visible light region (400 nm to 700 nm) and an absorptance of not less than 30 percents in the near infrared region (800 nm to 1000 nm) as an example of the invisible toner. In addition, in order to increase an ability of the absorption in the near infrared region, the invisible toner, as an example of the image forming material, having 100 nm to 600 nm as a range of an average dispersion diameter is adopted. Here, with regard to “visible” and “invisible,” they are independent of recognition with eyes. “Visible” and “invisible” are differentiated based on whether an image formed on the printed medium has a chromogenic property due to absorption of a specific wavelength in the visible light region. Additionally, “invisible” includes the region that is difficult to be recognized with human eyes and that has a little chromogenic property due to absorption of the specific wavelength in the visible light region.

As described above, in the first exemplary embodiment, a code pattern image is formed by the invisible toner with having absorptance in the range of near-infrared so that color of the image printed on a medium is not affected and the identity information and the location information are embedded.

The code pattern image provides a stable operation of capturing and the decoding processing with an infrared light emission for the long term, and is formed with an invisible image that records information with high density. It is also preferable that the invisible image gives less noise to the visible image on the surface of the medium on which the image is outputted. Moreover, for example, it is preferable that the invisible image is discriminated in terms of brightness difference from an area in which no images are formed. For example, an invisible image is formed on the entire surface of the medium (paper surface) while being adjusted with the size of the printed medium. However, “the entire surface” does not indicate that four corners of the sheet are all included. In an image forming apparatus using an electrophotographic method or the like, since the peripheral area of a paper sheet is usually unprintable, even if there is no printed invisible image on the peripheral area, an image is regarded as an image formed on “the entire surface.”

The two-dimensional code shown in FIG. 2B includes an area that stores location codes indicating the coordinate location on the medium and an area that stores identity codes that uniquely specify a medium. It also includes an area that stores synchronous codes. As shown in FIG. 2A, plural two-dimensional codes are arranged on a surface of the medium in a grid pattern. That is, on the surface of the medium, the plural two-dimensional codes as shown in FIG. 2B are arranged, each of which has the location codes, the identity codes and the synchronous codes. The area for the plural location codes stores the location information that is different, respectively, by the arranged location. On the other hand, the plural identity codes stores the same identity information independent of the arranged location.

In FIG. 2B, the location codes are arranged within a rectangle area of 6 bits by 6 bits. Each bit value is formed by a bitmap of plural minute lines with different rotation angles so as to represent bit values zero (0) and one (1) in the pattern images (a pattern 0 and a pattern 1) as shown in FIG. 2C. More specifically, using the backslash “\” and the slash “/” which have different inclination angles with each other, bit values 0 and 1 are represented. The pattern image has a size of 8 pixels by 8 pixels with 600 dpi, and a pattern image having a rising diagonal stroke from bottom right to top left (the pattern 0) represents the bit value 0, whereas a pattern image having a rising diagonal stroke from bottom left to top right (the pattern 1) represents the bit value 1. Thus, the different inclination angles of the pattern images represent one bit information (0 or 1).

In other words, the location code area shown in FIG. 2B stores the location information of 36 bits in total. According to the first exemplary embodiment, 18 bits out of 36 bits are used for encoding X-coordinate and the other 18 bits are used for encoding Y-coordinate. If 18 bits each is fully used for encoding the locations, 2¹⁸ (approximately 260 thousand) locations are encoded. In the first exemplary embodiment, each pattern image is composed of 8 pixels by 8 pixels (with 600 dpi), as shown in FIG. 2C. One dot size for 600 dpi is approximately 0.0423 mm, thus the size of the two-dimensional code (including the synchronous codes) in FIG. 2B is approximately 3 mm (8 pixels×9 bits×0.0423 mm) in length and width. If 260 thousand locations are encoded with 3-mm interval, the length of about 786 m is encoded. In this way, 18 bits all may be used for encoding locations, or if detection of the pattern image causes an error, redundant bits for error detection and error correction may be included.

The identity codes are arranged within rectangle areas of 2 bits by 8 bits and 6 bits by 2 bits, and stores the identity information of 28 bits in total. If 28 bits are used for the identity information, 2²⁸ types (about 270 million types) of the identity information are represented. The identity code may include redundant bits within 28 bits for error detection and error correction, similarly to the location code.

In an example as shown in FIG. 2C, two pattern images have angular difference of 90 degrees each other. If the angular difference is set to 45 degrees, four pattern images are formed. If such pattern images are formed, the pattern images represent information of two bits (0 to 3). In other words, by increasing variation of angles for pattern images, bit number to be represented may be increased.

In another example shown in FIG. 2C, encoding a bit value is explained using pattern images. However, other way than pattern images may be adopted. For example, a bit value may be encoded by using ON or OFF of dots or a direction of a dot deviated from a reference position.

Next, a description will be given to the digital pen 50 as an example of the electronic writing instrument according to the first exemplary embodiment.

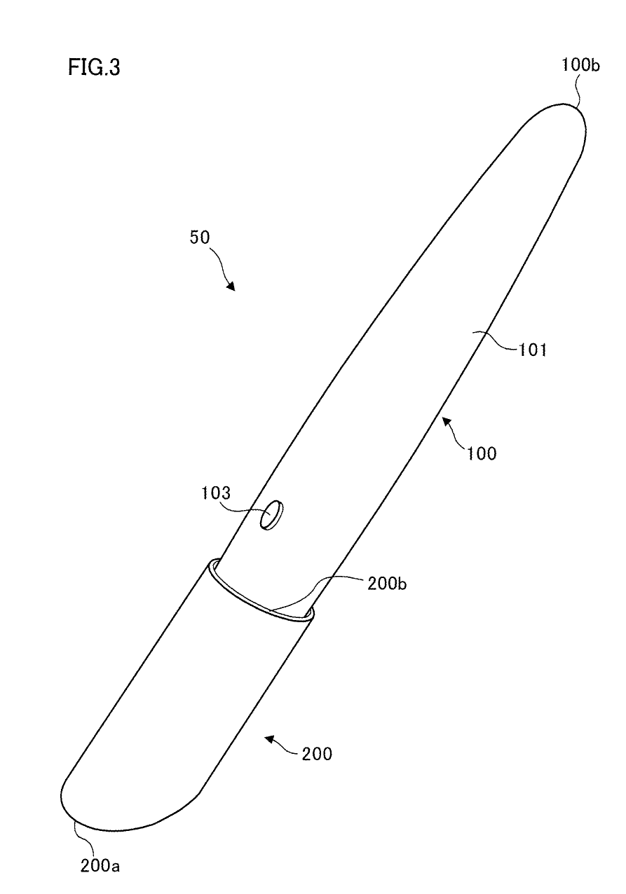

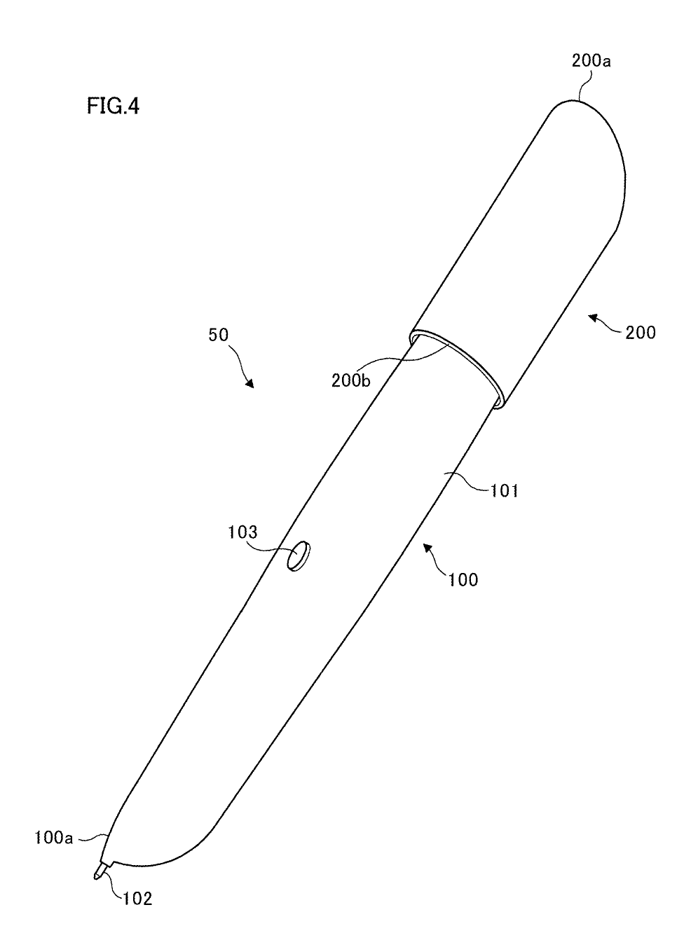

FIGS. 3 and 4 are perspective views showing a configuration of the digital pen 50. The digital pen 50 is equipped with an electronic writing instrument body portion 100 and a detachable cap 200 attached to the electronic writing instrument body portion 100.

The electronic writing instrument body portion 100 has an elongate shape, and has a pen tip end part 100a and a pen rear end part 100b as one end part and the other end part. In addition, the electronic writing instrument body portion 100 is equipped with a pen chassis 101 to which various component parts are attached, a pen tip 102 that is attached to the pen tip end part 100a side of the pen chassis 101 to write down on the printed material 40 or the like, and a switch 103 that is formed at the center of the pen chassis 101 so as to protrude from the pen chassis 101 and receives a switching operation between the above-mentioned writing mode and reference information acquiring mode.

In the first exemplary embodiment, the pen tip 102 is used as an example of a writing unit.

On the other hand, the cap 200 has a cap tip end portion 200a that becomes an end portion distal to the electronic writing instrument body portion 100 when the cap is attached to the electronic writing instrument body portion 100, and a cap rear end portion 200b which the electronic writing instrument body portion 100 is inserted into or removed from. As shown in FIGS. 3 and 4, the cap 200 has a shape so as to be put on the pen tip end part 100a or the pen rear end part 100b of the electronic writing instrument body portion 100. As shown in FIG. 3, in a state where the cap 200 is attached to the pen tip end part 100a of the electronic writing instrument body portion 100, the pen tip 102 is hidden by the cap 200, thereby resulting in a state where any writing is not performed. On the other hand, as shown in FIG. 4, in a state where the cap 200 is attached to the pen rear end part 100b of the electronic writing instrument body portion 100, the pen tip 102 is exposed to the outside, thereby resulting in a state where writing is performed.

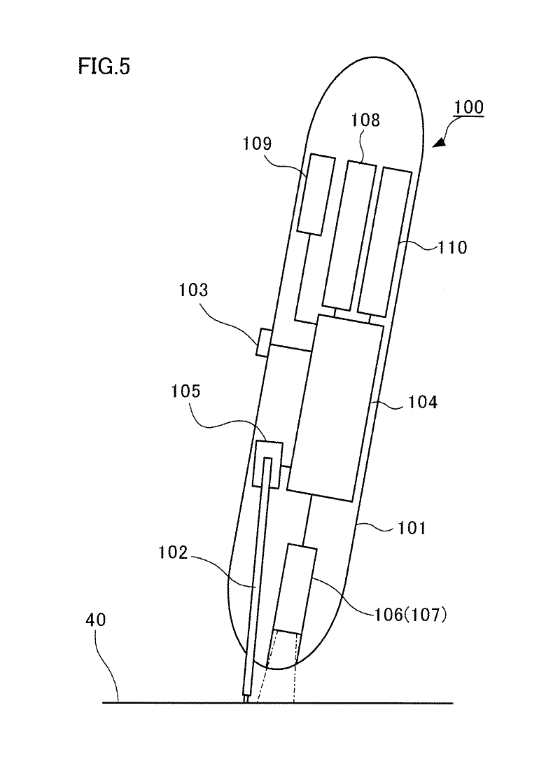

FIG. 5 shows a configuration of the inside of the electronic writing instrument body portion 100. The electronic writing instrument body portion 100 has a controller 104 that controls entire operations. The controller 104 is connected with a pressure sensor 105 that detects a writing operation of the electronic writing instrument body portion 100 by detecting a pressure applied to a pen tip 102. Further, the controller 104 is connected with a light emitting unit 106 that emits an infrared light on the printed material 40 and an image capture unit 107 that captures a code pattern image by detecting an infrared reflected light from the printed material 40. Furthermore, the controller 104 is connected with an information memory 108 for storing the identity information, the location information and the additional information, a communication unit 109 for communicating with external apparatuses such as the terminal apparatus 60, a battery 110 for driving each part, and a switch 103 that receive switching of an operation mode for the electronic writing instrument body portion 100. In the first exemplary embodiment, the light emitting unit 106 and the image capture unit 107 function as a capturing unit.

It should be noted that, in this embodiment, a condition in which the switch 103 is not pressed may be set to “the writing mode,” whereas another condition in which the switch 103 is once pressed may be set to “the reference information acquiring mode.” If the switch 103 is further pressed one more time in the case when “the reference information acquiring mode” is set, the condition returns to “the writing mode.”

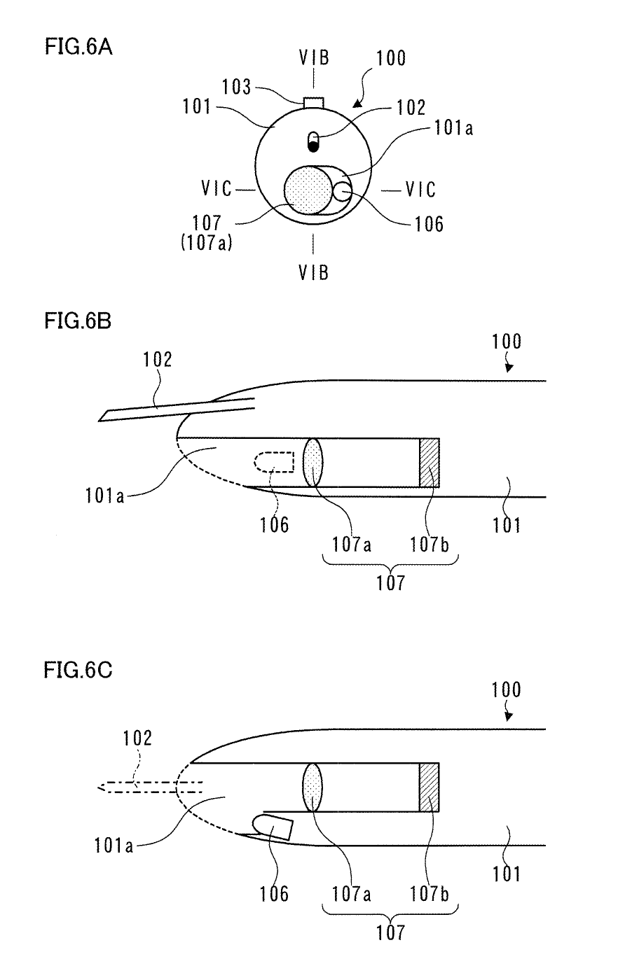

FIGS. 6A to 6C are diagrams for explaining the detailed configuration of the light emitting unit 106 and the image capture unit 107 provided in the electronic writing instrument body portion 100. FIG. 6A is a front view of the electronic writing instrument body portion 100 seen from the pen tip end part 100a, FIG. 6B is a VIB-VIB cross sectional view in FIG. 6A; and FIG. 6C is a VIC-VIC cross sectional view in FIG. 6A. On the pen tip end part 100a side of the electronic writing instrument body portion 100, a portion having an aperture 101a is formed at a position shifted from a position where the pen tip 102 is attached to the pen chassis 101. Inside the portion having the aperture 101a, the light emitting unit 106 and the image capture unit 107 are attached.

The light emitting unit 106 is configured by an infrared LED (Light Emitting Diode) that emits a light in the near infrared region (800 nm to 1000 nm).

On the other hand, in the first exemplary embodiment, the image capture unit 107 is equipped with a lens 107a that transmits and converges the above-mentioned light in the near infrared region, and an infrared light receiving element 107b that receives a light converged by the lens 107a. In this embodiment, an infrared CMOS (Complementary Metal Oxide Semiconductor) area sensor is used as the infrared light receiving element 107b.

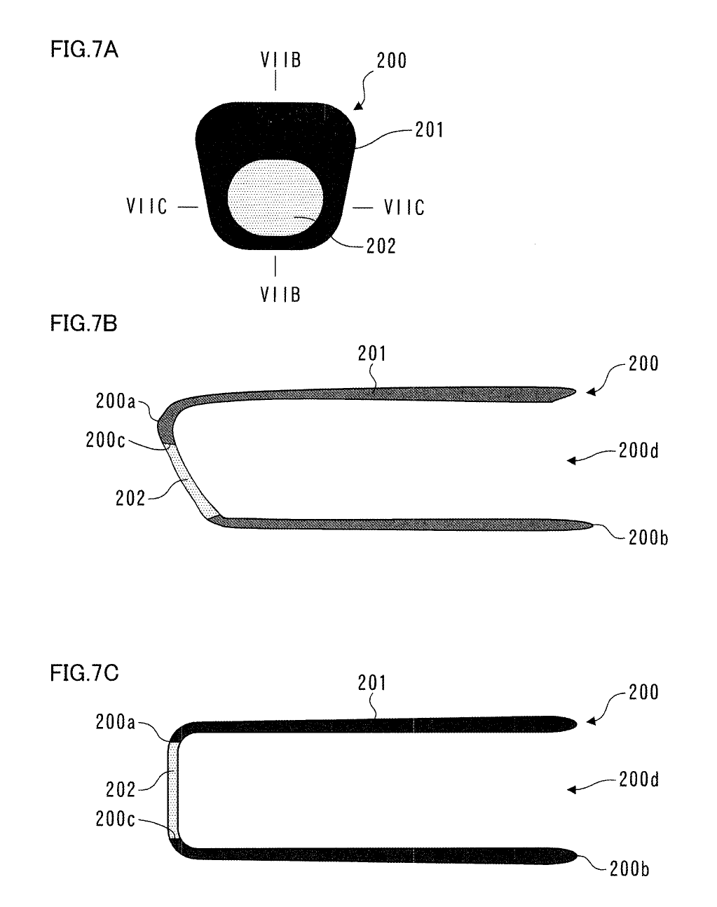

FIGS. 7A to 7C are diagrams for explaining a detail configuration of the cap 200. Here, FIG. 7A is a front view of the cap 200 seen from the cap tip end portion 200a, FIG. 7B is a VIIB-VIIB cross sectional view in FIG. 7A, and FIG. 7C is a VIIC-VIIC cross section view in FIG. 7A.

The cap 200 has a cap body portion 201 having a U shaped cross section. A portion having an opening hole 200c is formed at the side where the cap tip end portion 200a of the cap 200 is located. Into the portion having the opening hole 200c, a cover 202 which is an example of a transmitting member according to the first exemplary embodiment is fitted. Here, the cap tip end portion 200a of the cap body portion 201 is arranged in a state inclined to the side surface as shown in FIG. 7B, and the cover 202 is also arranged along with the inclination. At the side where the cap rear end portion 200b of the cap 200 is located, a portion having a insertion hole 200d for inserting the electronic writing instrument body portion 100 is formed.

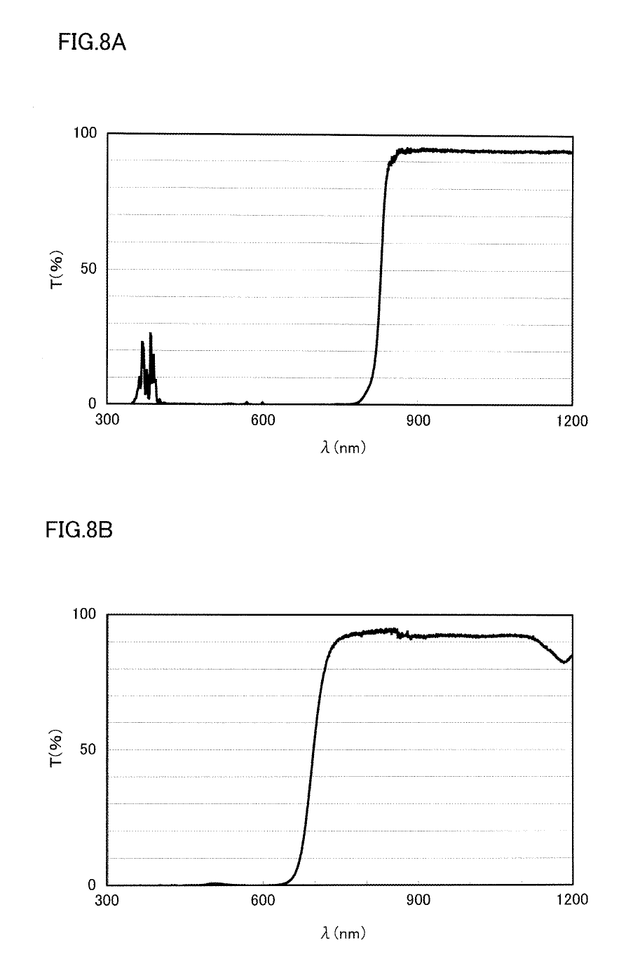

FIGS. 8A and 8B show the light transmission characteristics of the cover 202 provided in the cap 200. In FIGS. 8A and 8B, the horizontal axis shows the wavelength X (nm) while the vertical axis shows the light transmission rate T (%). Here, FIG. 8A illustrates characteristics in the case where a so-called interference type filter in which an interference layer such as a dielectric multi-layer film is formed on a transparent substrate such as glass and acrylic resin is used as the cover 202. On the other hand, FIG. 8B illustrates characteristics in the case where a so-called absorption type filter in which an absorbing agent having a light absorption property in the visible region is included in a transparent substrate such as glass and acryl resin is used as the cover 202. In these cases, the above both filters are designed to have characteristics of blocking lights in the visible area having a wavelength of 350 to 700 nm.

In the case of using the interference type filter, rising at a cutoff wavelength becomes steeper than that in the case of using the absorption type filter. On the other hand, the absorption type filter has a simpler structure than the interference type filter, resulting in the cost reduction. Thus, the absorption type filter or the interference type filter may be selected appropriately according to the functions and characteristics required.

Here, the printed material 40 that is to be written or captured by the digital pen 50 is described with referring to an example. The printed material 40 is an example of a medium according to the first exemplary embodiment. FIG. 9 shows a carte form of a carte sheet 41 as an example of the printed material 40. In an image forming apparatus 30 shown in FIG. 1, by using the visible toner, layout information such as ruled lines of the carte form is printed on the carte sheet 41. At the same time, in the image forming apparatus 30, by using the invisible toner, a carte ID which is an example of the identity information to uniquely specify the sheet one by one, and the code pattern image which indicates the location information (coordinate information) on the carte sheet 41 are printed on the entire surface of the carte sheet 41.

As shown in FIG. 9, the carte form of the carte sheet 41 includes a patient basic information entry field 411 for filling in a patient's name, the birth date, the patient's face photo, the previous disease, the allergy information and the like, and a handwriting information entry field 412 corresponding to, for example, a carte form of a second format. In addition, the carte form includes an entry type selection field 413, a past history information reference field 414 and a system linking function field 415. On the carte form, a transparent image 416 is additionally formed using the invisible toner.

As mentioned above, on the entire surface of the carte sheet 41, the carte ID as an example of the identity information, and the location information on the sheet are printed as a code pattern image. If a handwriting input is performed on the carte sheet 41 using the digital pen 50 that may capture the code pattern image, the carte ID and the location information are detected by the digital pen 50 at the same time. With the above operation, the digital pen 50 acquires information of the carte sheet 41 currently used and information of the location on which the handwriting input is performed, as electronic information. Since a transparent image 416 with the invisible toner is printed, the printed carte sheet 41 is visually confirmed to be a sheet on which the code pattern image including the identity information and the location information with the invisible toner is printed by the difference of brightness between the transparent image 416 and the carte sheet 41.

For the medical examination of a patient, a doctor enters a medical records into the handwriting information entry field 412 formed in the carte form of the carte sheet 41 using the digital pen 50. At this time, the digital pen 50 is set to the writing mode by an operation of the switch 103. The digital pen 50 captures the printed code pattern image, detects the carte ID and the moving trace of the digital pen 50 on the carte sheet 41, and recognizes the carte and the contents of the handwriting input. Then, the handwriting result is displayed on the terminal apparatus 60 in a state where the handwriting result is superimposed on the electronic document that is a source of the carte sheet 41.

The contents that are written in the handwriting information entry field 412 of the carte sheet 41 includes, for example, contents associated with S, O, A and P shown in the entry type selection field 413 in FIG. 9. For example, a patient's subjective information is entered by specifying the subjective complaint (S: subjective). The doctor's medical examination observation and inspection observation are entered by specifying the objective finding (O: objective). The assessment, the discrimination assessment, the medical treatment selection and the reason, and the evaluation of the medical treatment by the doctor are entered by specifying the assessment (A: assessment). The medical treatment plan and others are entered by specifying the plan (P: plan).

When a doctor wishes to make reference to, for example, the past medical history that is not described in the carte sheet 41 during a medical examination for a patient, the digital pen 50 is set to the reference information acquiring mode by the operation of the switch 103. The digital pen 50 captures the code pattern image printed within “□” column in the past history information reference field 414 formed in the carte form of the carte sheet 41, that is, a specific area, and recognizes the carte ID and the location information of the digital pen 50 on the carte sheet 41. Thus, an electronic document corresponding to the carte ID and the location information is read out and displayed on the terminal apparatus 60.

When a doctor wishes to make reference to the test status, the treatment status, the prescription status and the reservation status of the patient that are not described in the above carte sheet 41, the corresponding “□” column of the system linking function field 415 formed on the carte form of the carte sheet 41, that is, the code pattern image printed on a specific area, is captured by the digital pen 50 with remaining in the reference information acquiring mode. Then, the carte ID and the location information are acquired from the captured code pattern image, and an electronic document corresponding thereto is displayed on the terminal apparatus 60.

Next, how to capture a code image on the printed material 40 such as the carte sheet 41 using the digital pen 50 is specifically described.

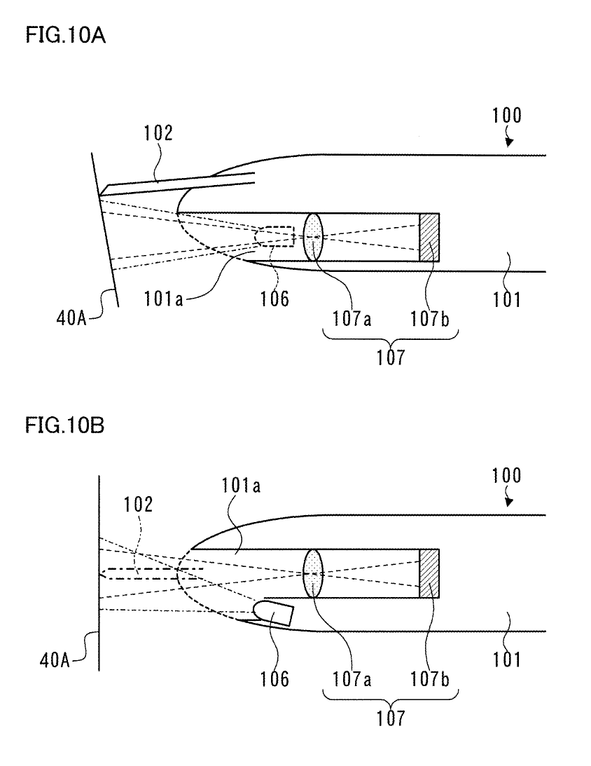

FIGS. 10A and 10B are diagrams for explaining how to capture the code image in the first mode, that is, in the writing mode. Here, FIG. 10A is a cross sectional view of the electronic writing instrument body portion 100 corresponding to FIG. 6B, while FIG. 10B is a cross sectional view of the electronic writing instrument body portion 100 corresponding to FIG. 6C.

In the writing mode, the pen tip 102 on the electronic writing instrument body portion 100 is used for writing down on the printed material 40. For this purpose, in the writing mode, the cap 200 is removed from the side where the pen tip end part 100a of the electronic writing instrument body portion 100 is located. The cap 200 removed is, for example, as shown in FIG. 4, attached to the pen rear end part 100b.

At the writing mode, a top of the pen tip 102 provided on the electronic writing instrument body portion 100 is in contact with the printed material 40. In the explanation, the surface of the printed material 40 subjected to writing is referred to as a virtual writing surface 40A. When the writing is made, the electronic writing instrument body portion 100 is, as shown in FIG. 10A and FIG. 5, put in a state where the electronic writing instrument body portion 100 is inclined to the virtual writing surface 40A. This is the same state as that where the writing is made with a normal pen.

In such a state, the light emitting unit 106 emits the light (dashed lines in the figure) to the virtual writing surface 40A. Then, the light emitted to the virtual writing surface 40A is reflected according to the presence or absence of the code image. Then, part of the reflected light from the virtual writing surface 40A (dotted lines in the figure) is converged by the lens 107a of the image capture unit 107 and captured as image by the infrared light receiving element 107b. In this embodiment, the image capture unit 107 is arranged on the position where a diffused light from the virtual writing surface 40A is detected. In addition, the emission area on the virtual writing surface 40A by the light emitting unit 106 is set wider than the light-receiving area on the virtual writing surface 40A by the image capture unit 107.

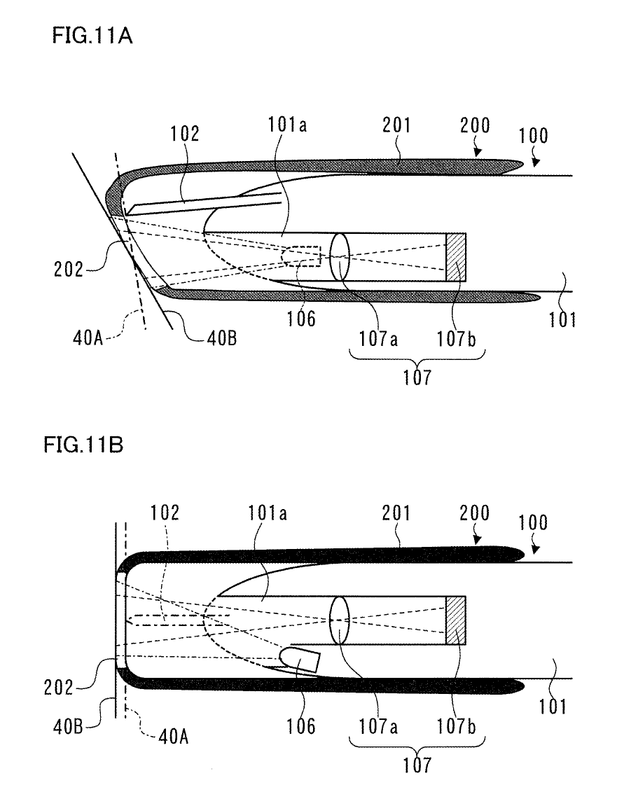

Meanwhile, FIGS. 11A and 11B are diagrams for explaining how to capture a code image in the second mode, that is, in the reference information acquiring mode. Here, FIG. 11A is a cross sectional view of the electronic writing instrument body portion 100 and the cap 200 corresponding to FIG. 7B, while FIG. 11B is a cross sectional view of the electronic writing instrument body portion 100 and the cap 200 corresponding to FIG. 7C.

In the reference information acquiring mode according to the first exemplary embodiment, the cap 200 is attached to the side where the pen tip end part 100a of the electronic writing instrument body portion 100 is located. At this time, the portion having the aperture 101a provided on the pen chassis 101 of the electronic writing instrument body portion 100 is arranged on a position opposed to the cover 202 which is attached to the cap body portion 201 of the cap 200.

By so doing, when capturing of a specific area on the printed material 40 is made in the reference information acquiring mode, the pen point of the pen tip 102 provided on the electronic writing instrument body portion 100 is covered with the cap 200 and is not in contact with the printed material 40. In this explanation, the surface of the printed material 40 subjected to capturing is referred to as a virtual reading surface 40B. When capturing is made, the electronic writing instrument body portion 100 is also put in a position where the electronic writing instrument body portion 100 is inclined to the virtual reading surface 40B as shown in FIG. 11A. Here, since the cap 200 is attached, the virtual reading surface 40B in the reference information acquiring mode differs in the angle and the position from those of the virtual writing surface 40A in the writing mode. In this embodiment, however, on the side where the cap tip end portion 200a of the cap 200 is located, an inclination toward the optical axis direction is given, and the cover 202 is attached thereto, thus, compared with a case where no inclination is given, there is less difference between the virtual writing surface 40A and the virtual reading surface 40B on the distance from the image capture unit 107.

In such a state, the light emitting unit 106 emits the light to the cap 200. Here, the cap 200 has the cover 202 that transmits a near-infrared light, thus the light is transmitted through the cover 202 and emitted to the virtual reading surface 40B. Next, the light emitted to the virtual reading surface 40B is reflected according to the presence or absence of the code image. Then, part of the reflected light from the virtual reading surface 40B is transmitted through the cover 202 provided in the cap 200 and is converged by the lens 107a of the image capture unit 107 through the cover 202, and captured as image by the infrared light receiving element 107b. In the reference information acquiring mode, the image capture unit 107 also receives a diffused light from the virtual reading surface 40B. In addition, the emission area on the virtual reading surface 40B by the light emitting unit 106 is set wider than the light-receiving area on the virtual reading surface 40B by the image capture unit 107.

As described above, in the digital pen 50, the cover 202 that transmits the light in the near-infrared region is provided in the cap 200 to be attached to the electronic writing instrument body portion 100, thus even the cap 200 is attached to the side where the pen tip end part 100a of the electronic writing instrument body portion 100 is located, and the code image formed on the printed material 40 may be captured. However, as it is clear from FIG. 11, the position of capturing the code image differs between the virtual writing surface 40A and the virtual reading surface 40B, thus, in the writing mode or the reference information acquiring mode, an image of the received light on the infrared light receiving element 107b may be blurred.

Therefore, in the first exemplary embodiment, settings are performed in advance so that both the virtual writing surface 40A and the virtual reading surface 40B are included within a range of the depth of field of optical systems. These settings are specifically described below.

In order to assure the capturing performance for a code image formed on the printed material 40 such as the carte sheet 41, it is required that, a specific dot and an adjacent dot that is adjacent to the specific dot on the code image are identified as different dots based on the light receiving data received by the infrared light receiving element 107b. Here, a distance between the printed material 40 and the infrared light receiving element 107b, when the specific dot and the adjacent dot are identified as two different points, are referred to as a depth of field D. The depth of field D has a specific width and is represented by the equation (1) using the front depth of field Dn that is a limiting point in the side near to the lens 107a, and the rear depth of field Df that is a limiting point away from the lens 107a. The front depth of field Dn is represented by the equation (2), while the rear depth of field Df is represented by the equation (3), respectively. A hyperfocal distance H used in the equations (2) and (3) is represented by the equation (4).

$$\begin{matrix}D = Df - Dn & ( 1 ) \\ Dn = \frac{s \cdot ( H - f )}{H + s - 2 f} & ( 2 ) \\ Df = \frac{s \cdot ( H - f )}{H - s} & ( 3 ) \\ H = \frac{{f}^{2}}{N \cdot c} & ( 4 )\end{matrix}$$

D: depth of field
Dn: front depth of field
Df: rear depth of field
H: hyperfocal distance
f: focal length
d: aperture diameter
s: subject distance
N: f value of the optical systems (=f/d)
c: diameter of permissible circle of confusion

Provided that the diameter of the permissible circle of confusion c on the infrared light receiving element 107b required to capture a code image is 20 μm, that is, 0.02 mm, the depth of field D becomes 11.1 mm when the aperture diameter d=1 mm, focal length f=9 mm, and the subject distance s=54 mm.

Thus, it may be sufficient that the electronic writing instrument body portion 100 and the cap 200 comprising the digital pen 50 are optically designed so that the virtual writing surface 40A and the virtual reading surface 40B are located within the depth of field D thus calculated.

In this embodiment, the cover 202 made of materials with higher index of refraction than the air, such as glass and acrylic resin, is arranged in the cap 200. In the reference information acquiring mode, a reflected light from the virtual reading surface 40B enters the image capture unit 107 via the cover 202. By providing the above-mentioned cover 202, even when the virtual reading surface 40B is away from the virtual writing surface 40A, the image capture unit 107 acquires a similar image to that obtained in the case where the actual distance is shortened by the light path length difference ΔL due to the presence or absence of the cap 200. Here, the optical path difference ΔL is represented by the equation (5). Sin θ2 used in the equation (5) is represented by the equation (6).

$$\begin{matrix}Δ L = \frac{t \cdot ( tan θ 1 - tan θ 2 )}{tan θ2} & ( 5 ) \\ sin θ 2 = \frac{sin θ1}{n 2} & ( 6 )\end{matrix}$$

ΔL: optical path difference
θ1: half angle for the entrance pupil on the side where the subject is located in the optical systems
θ2: incident angle to the cover
t: thickness of the cover
n2: index of refraction of the cover

As the cover 202, for example, a glass with an index of refraction n2=1.51 and a thickness t=3 mm is arranged, provided that the subject distance is 54 mm and the pupil diameter is 1 mm, the light path length difference ΔL becomes 1 mm. By capturing the code image via the cover 202 in this way, the focus position in the reference information acquiring mode moves 1 mm away from that in the writing mode.

In this embodiment, the cover 202 having the infrared transmission characteristics is attached to the cap body portion 201 of the cap 200. However, it is not limited to this. As the cover 202, a material having the light transmission characteristics in the visible region and the near-infrared region, such as glass and acrylic resin having no filter function, may be used. If a material that produces the Pockels effect and Kerr effect is used as the cover 202, fine tuning of the index of refraction is available according to the voltage applied to the cover 202. Even when the cover 202 is not attached to the cap body portion 201 and the portion having the opening hole 200c is opened, the pen tip 102 in the reference information acquiring mode is protected and also capturing of the code image formed on the printed material 40 is performed. In addition, the entire cap 200 maybe composed of a material having the infrared transmission characteristics.

Meanwhile, in the first exemplary embodiment, the cover 202 having the transmission characteristics in the range of the wavelength of 800 nm to 1200 nm is used. Alternatively, if another cover 202 having a narrower transmission range of, for example, 800 nm to 1000 nm, corresponding to the emission light by the light emitting unit 106 is used, the wavelength selectivity is further improved.

Independent of the light emitting unit 106 and the image capture unit 107 which are provided in the electronic writing instrument body portion 100, the cap 200 may have a function for capturing an infrared image.

In the first exemplary embodiment, the case where the cap 200 is attached to the electronic writing instrument body portion 100 is explained as the reference information acquiring mode, and the case where the cap 200 is removed is explained as the writing mode. Not limited to this, however, in the state of removing the cap 200, both the writing mode and the reference information acquiring mode may be performed by using the switch 103.

In the first exemplary embodiment, a code pattern image in which the carte ID and the location information are embedded is captured in the reference information acquiring mode. However, not limited to this, any code pattern image in which any information such as URL information is embedded may be captured as far as the reference information may be obtained.

### Second Exemplary Embodiment

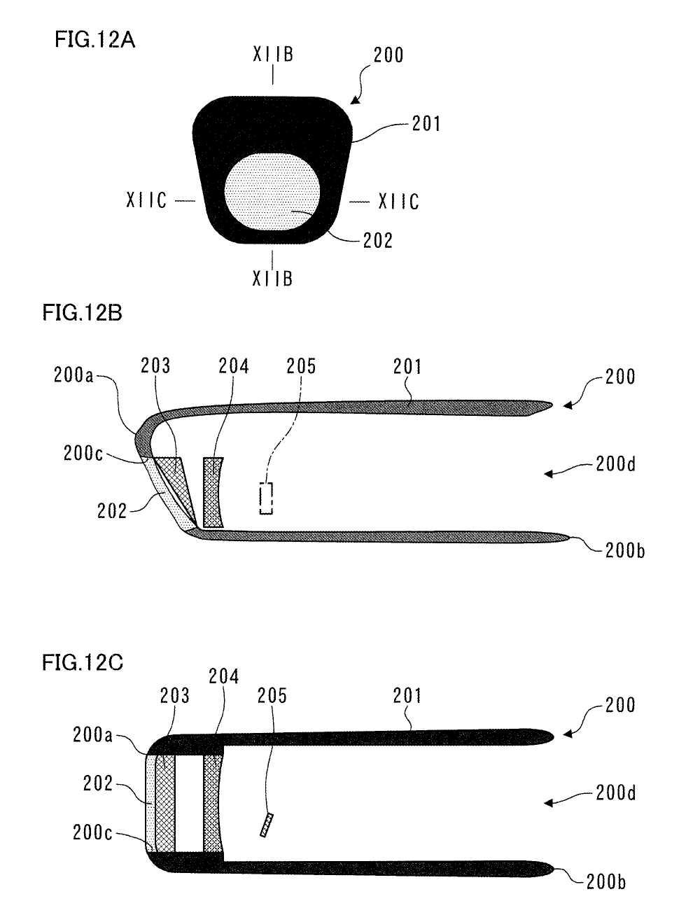

FIGS. 12A to 12C are diagrams for explaining a detailed configuration of the cap 200 used for the digital pen 50 according to the second exemplary embodiment. Here, FIG. 12A is a front view of the cap 200 seen from the cap tip end portion 200a; FIG. 12B is a XIIB-XIIB cross sectional view in FIG. 12A; and FIG. 12C is a XIIC-XIIC cross sectional view in FIG. 12A.

In addition to the cap body portion 201 and the cover 202, the cap 200 is further provided with a first optical element 203, a second optical element 204 and a third optical element 205. Among these, the first optical element 203 is fixed to the cap body portion 201 at the inside of the cap body portion 201 and at the rear side of the cover 202. The second optical element 204 is fixed to the cap body portion 201 at the inside of the cap body portion 201 and at the rear side of the first optical element 203. The third optical element 205 is fixed to the cap body portion 201 at the inside of the cap body portion 201 and at the rear side of the second optical element 204.

The first optical element 203 used as an example of an emission area changing member or a light receiving area changing member is configured by a material having light transmission characteristics in the near-infrared region and having an index of refraction higher than the air, such as glass and acrylic resin, processed in a prism shape. The second optical element 204 used as an example of a focus changing member in the second exemplary embodiment includes those configured by a concave lens having the light transmission characteristics in the near-infrared area, such as glass and acrylic resin. The third optical element 205 that functions as an example of an emission area changing member according to the second exemplary embodiment includes those configured by a plate-shaped infrared transmission filter having the light transmission characteristics in the near-infrared area. The cap body portion 201 and the cover 202 are the same as those in the first exemplary embodiment.

The electronic writing instrument body portion 100 configuring the digital pen 50 together with the cap 200, which is the same as that described in the first exemplary embodiment, is used.

Hereinafter, capturing of a code image on the printed material 40 by the digital pen 50 is specifically described. However, capturing of the code image in the writing mode is omitted here since it is the same as the first exemplary embodiment.

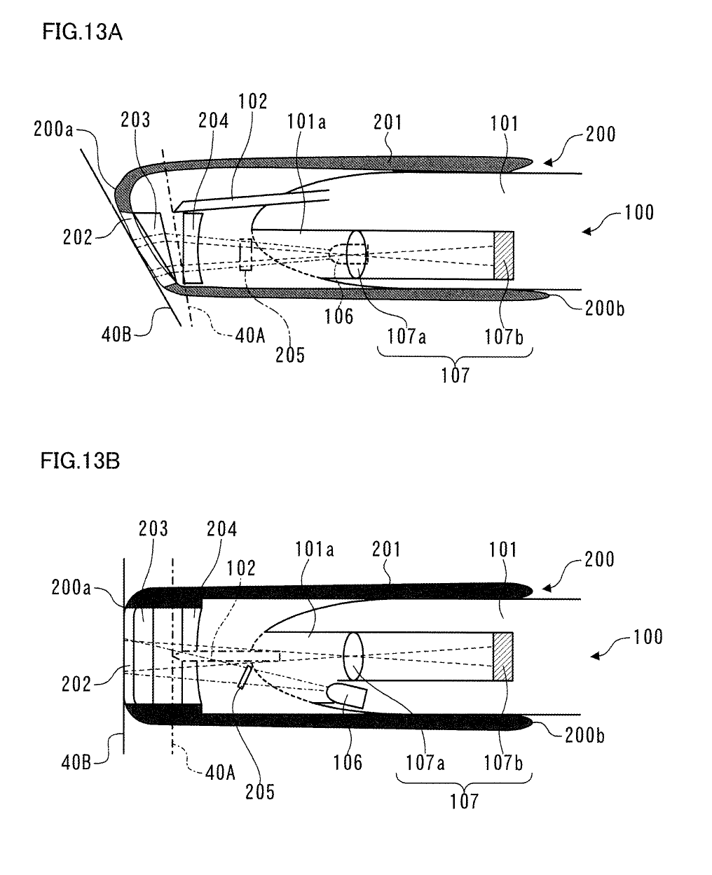

FIGS. 13A and 13B are diagrams for explaining the capturing of the code image in the reference information acquiring mode. Here, FIG. 13A is a cross sectional diagram of the electronic writing instrument body portion 100 and the cap 200 corresponding to FIG. 12B, while FIG. 13B is a cross sectional diagram of the electronic writing instrument body portion 100 and the cap 200 corresponding to FIG. 12C.

In the reference information acquiring mode, the cap 200 is attached to the side where the pen tip end part 100a of the electronic writing instrument body portion 100 is located. Here, the portion having the aperture 101a provided in the pen chassis 101 of the electronic writing instrument body portion 100 is arranged at the position opposed to the cover 202 attached to the cap body portion 201 of the cap 200. Here, the first optical element 203 is arranged so that the thickness of the first optical element 203 is thicker on the side near to the pen tip 102 in the optical axis direction, and the thickness is thinner on the side away from the pen tip 102. The attachment position of the second optical element 204 provided in the cap 200 is determined in advance so that the second optical element 204 is not in contact with the pen tip 102, when the cap 200 is put on the side where the pen tip end part 100a of the electronic writing instrument body portion 100 is located. In addition, the third optical element 205 is attached so that it is opposed to the light emitting unit 106 and inclined to the light emitting direction from the light emitting unit 106.

In such a state, the light emitting unit 106 emits a light. The light emitting unit 106 emits the light to the virtual reading surface 40B via the third optical element 205, the second optical element 204 and the first optical element 203 equipped in the cap 200. Next, the light emitted to the virtual reading surface 40B is reflected according to the presence or absence of the code image. Then, part of the reflected light from the virtual reading surface 40B is transmitted through the cover 202, the first optical element 203, and the second optical element 204 equipped in the cap 200 and is converged by the lens 107a of the image capture unit 107, and captured as image by the infrared light receiving element 107b.

In the second exemplary embodiment, since the third optical element 205 is arranged to be inclined to the light emitting direction of the light emitting unit 106, a light emitted from the light emitting unit 106 is refracted when it is transmitted through the third optical element 205. Thus, the light emitting unit 106 emits the light with a larger inclination to the virtual reading surface 40B, thereby the reflected light from the virtual reading surface 40B becomes more difficult to enter the image capture unit 107. By attaching the cover 202 inclined to the same direction as the third optical element 205 relative to the light emitting direction from the light emitting unit 106 without attaching the third optical unit 205 separately, the cover 202 may have a function of the third optical element 205.

In the second exemplary embodiment, since the second optical element 204 configured by a concave lens is provided in the path of the reflected light, the focal distance in the reference information acquiring mode becomes longer than that in the writing mode. By providing the second optical element 204, even when the virtual reading surface 40B is located away from the position of the virtual writing surface 40A, defocusing on the infrared light receiving element 107b of the image capture unit 107 may be suppressed in both the writing mode and the reference information acquiring mode.

Furthermore, in the second exemplary embodiment, by providing the first optical element 203, a light emitted from the light emitting unit 106 is refracted to the direction away from the pen tip 102 to be emitted to the virtual reading surface 40B, and a reflected light from the virtual reading surface 40B is refracted and enters the image capture unit 107. By adopting such a configuration, the light emission range and the code image capturing range in the reference information acquiring mode are moved away from the pen point position of the pen tip 102. Similarly to the cover 202, by the light refraction generated at the first optical element 203, a substantial focus position is moved away.

In this explanation, the thickness of the first optical element 203 along the optical axis direction is made thicker on the side near to the pen tip 102, and thinner on the side away from the pen tip 102. However, it is not limited to this. For example, the thickness on the side near to the pen tip 102 may be made thinner while that on the side away from the pen tip 102 may be made thicker. In this case, the light emission range and the code image capturing range in the reference information acquiring mode becomes closer to the pen point position of the pen tip 102.

### Third Exemplary Embodiment

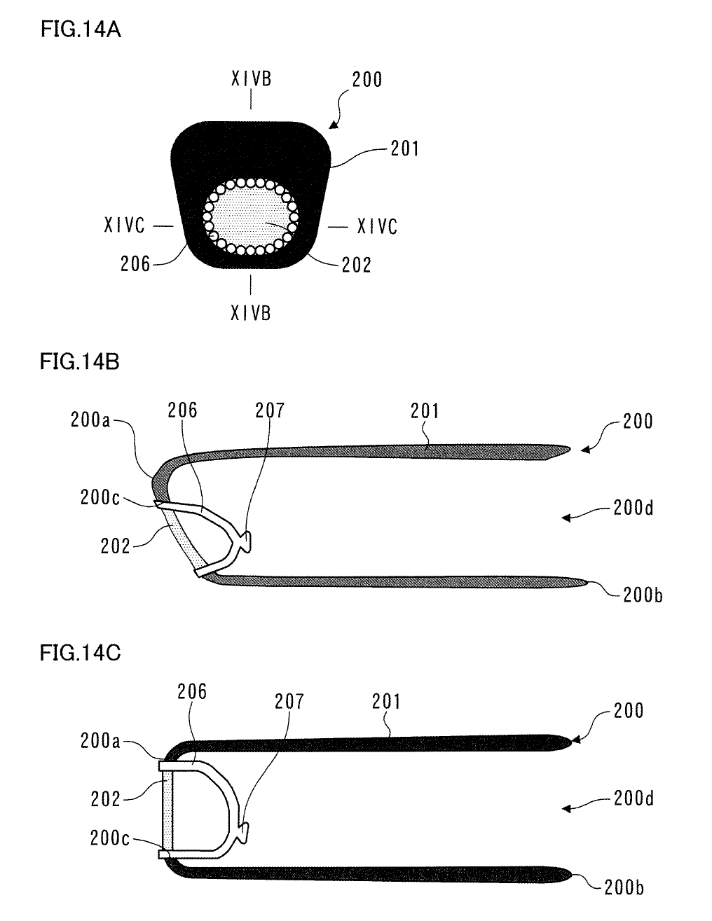

FIGS. 14A to 14C are diagrams for explaining the detailed configuration of the cap 200 used for the digital pen 50 according to the third exemplary embodiment. Here, FIG. 14A is a front view of the cap 200 seen from the cap tip end portion 200a. FIG. 14B is a XIVB-XIVB cross sectional view in FIG. 14A. FIG. 14C is a XIVC-XIVC cross sectional view in FIG. 14A.

In addition to the cap body portion 201 and the cover 202, the cap 200 is equipped with an optical guide fiber 206 and a converging unit 207. Among these, the optical guide fiber 206 is provided inside the cap body portion 201. One end side of the optical guide fiber 206, a converging unit 207 is provided. The other end side of the optical guide fiber 206 is arranged to be slightly protruded outside from a portion between the periphery of the cover 202 and the cap body portion 201. Here, plural optical guide fibers 206 are provided and arranged so as to surround the periphery of the cover 202. The converging unit 207 has a flat surface, and the opposite surface thereof is connected with the optical guide fiber 206. The optical guide fibers 206 and the converging unit 207 are fixed to the cap body portion 201.

The optical guide fiber 206 and the converging unit 207 are made of a material which has optical transparency in the near-infrared region, such as glass and acrylic resin. The cap body portion 201 and the cover 202 are similar to those in the first exemplary embodiment.

The electronic writing instrument body portion 100 that configures the digital pen 50 together with the cap 200, which is the same as that described in the first exemplary embodiment, is used.

Hereinafter, capturing of a code image on the printed material 40 by the digital pen 50 is specifically described. However, capturing of the code image in the writing mode is omitted here since it is the same as the first exemplary embodiment.

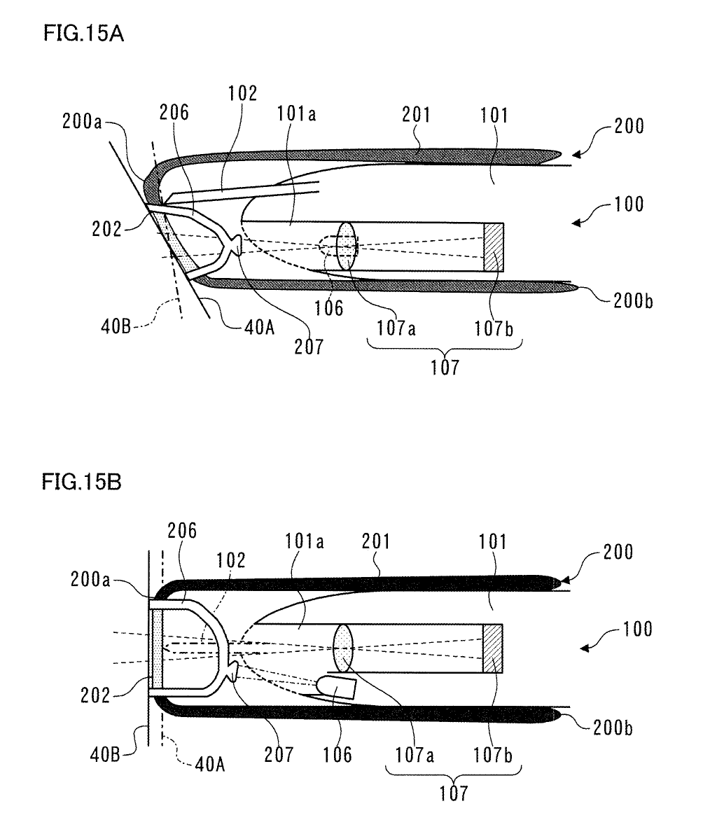

FIGS. 15A and 15B are diagrams for explaining the capturing of the code image in the reference information acquiring mode. Here, FIG. 15A is a cross sectional diagram of the electronic writing instrument body portion 100 and the cap 200 corresponding to FIG. 14B, while FIG. 15B is a cross sectional diagram of the electronic writing instrument body portion 100 and the cap 200 corresponding to FIG. 14C.

In the reference information acquiring mode, the cap 200 is attached to the side where the pen tip end part 100a of the electronic writing instrument body portion 100 is located. Here, the portion having the aperture 101a provided in the pen chassis 101 of the electronic writing instrument body portion 100 is arranged at the position opposed to the cover 202 attached to the cap body portion 201 of the cap 200. The converging unit 207 provided in the cap 200 is arranged at the position opposed to the light path of the light emitting unit 106.

In this state, the light emitted from the light emitting unit 106 enters the converging unit 207 provided in the cap 200, and is emitted to the virtual reading surface 40B via the plural optical guide fibers 206. By emitting light with plural optical guide fibers 206, unevenness of the light quantity on the virtual reading surface 40B is suppressed. Then, part of the reflected light from the virtual reading surface 40B is transmitted at the cover 202 provided in the cap 200, is converged by the lens 107a of the image capture unit 107, and is captured as image by the infrared light receiving element 107b. Here, the optical guide fiber 206 is arranged so as to avoid the path of the reflected light.

In the third exemplary embodiment, the optical guide fibers 206 and the converging unit 207 are used to guide the light emitted from the light emitting unit 106 toward the printed material 40, thus a state where a regularly reflected light from the light emitting unit 106 is received by the image capture unit 107 is avoided.

In the third exemplary embodiment, since the plural optical guide fibers 206 are arranged in a state where the plural optical guide fibers 206 are protruded from the cover 202, it is difficult to bring the cover 202 into contact with the virtual reading surface 40B, that is, the printed material 40, directly. Thus, the cover 202 is not easily scratched.

Moreover, in the third exemplary embodiment, if the other end side of the optical guide fiber 206, that is, the light emitting direction, is arranged to be directed toward the center of the cover 202, it becomes easy to fit the read area of the image capture unit 107 with the emission area of the light emitting unit 106.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electronic writing instrument comprising:
an electronic writing instrument body portion that captures a code image formed on a medium based on reflected light, the electronic writing instrument body portion having: at one end side thereof,
a writing unit that writes down on the medium on which the code image is formed;
a light emitting unit that emits light to the medium; and
an image capture unit that captures an image from reflected light reflected on the medium by the emitting light; and
a detachable cap that is attached to the one end side of the electronic writing instrument body portion and is configured so as to cover the writing unit when attached to the one end side, and to pass emitted light from the light emitting unit and the reflected light from the medium.

2. The electronic writing instrument according to claim 1, wherein the cap comprises:
a cap body portion that fits to the electronic writing instrument body portion, and
a portion having an aperture that is formed on the cap body portion, and configures a optical path of the emitted light to the medium and the reflected light from the medium to the image capture unit.

3. The electronic writing instrument according to claim 2, further comprising a transmitting member that is attached to the portion having the aperture and transmits the emitted light and the reflected light.

4. The electronic writing instrument according to claim 3, wherein the transmitting member selectively transmits light with a specific wavelength in the emitted light and the reflected light.

5. The electronic writing instrument according to claim 1, wherein the cap further comprises a focus changing member that changes a focus position of the reflected light in the case where the cap is mounted as compared with the case where the cap is not mounted.

6. The electronic writing instrument according to claim 1, wherein the cap further comprises an emission area changing member that changes an emission area on the medium where the emitted light is emitted in the case where the cap is mounted as compared with the case where the cap is not mounted.

7. The electronic writing instrument according to claim 1, wherein the cap further comprises a light receiving area changing member that changes a light receiving area where the reflected light from the medium is received in the case where the cap is mounted as compared with the case where the cap is not mounted.

8. The electronic writing instrument according to claim 1, wherein
the cap further comprises a portion having an insertion hole where the electronic writing instrument body portion is inserted, and
an end portion of the cap opposite to the portion having the insertion hole is formed so as to be inclined with respect to the axis direction of the cap body portion.

9. The electronic writing instrument according to claim 1, wherein
the electronic writing instrument body portion operates in a first mode where writing information is acquired based on the reading of the code image on the medium corresponding to writing operation to the medium by the writing unit, and in a second mode where reference information is acquired based on the reading of the code image formed in a specific area on the medium, and
the cap is removed from the one end side of the electronic writing instrument body portion in the first mode, and the cap is attached to the one end side in the second mode.

10. A cap comprising:
a cap body portion that includes a portion having an insertion hole where an electronic writing instrument body portion is inserted, the electronic writing instrument body portion having, at an end side, a writing unit that writes down on a medium on which a code image is formed and a capture unit that captures the code image on the medium;
a portion having an aperture that is formed on the cap body portion at an end portion opposite to the portion having the insertion hole of the cap body portion; and
a transmitting member that is attached to the portion having the aperture and transmits light with a specific wavelength used for reading by the capture unit.

11. The cap according to claim 10, wherein the transmitting member selectively transmits light with the specific wavelength in emitted light that is emitted from the electronic writing instrument body portion to the medium and in reflected light that is reflected on the medium.

12. The cap according to claim 11, further comprising a focus changing member that changes a focus position of the reflected light in the case where the electronic writing instrument body portion is inserted thereinto.

13. The cap according to claim 11, further comprising an emission area changing member that changes an emission area where the emitted light is emitted in the case where the electronic writing instrument body portion is inserted thereinto.

14. A computer system comprising:
an electronic writing instrument including an electronic writing instrument body portion and a cap; and
an information processing apparatus that performs a predetermined processing based on information related to a code image received from the electronic writing instrument, wherein
the electronic writing instrument body portion of the electronic writing instrument reads the code image formed on a medium based on received light, and has: at one end side,
a writing unit that writes down on the medium on which the code image is formed;
a light emitting unit that emits light to the medium; and
a image capture unit that captures an image from reflected light reflected on the medium by the emitting light, and
the cap of the electronic writing instrument is detachably attached to the one end side of the electronic writing instrument body portion and is configured so as to cover the writing unit when attached to the one end side, and to pass emitted light from the light emitting unit and the reflected light from the medium.

15. An electronic writing method of an electronic writing instrument including an electronic writing instrument body portion and a detachable cap, the electronic writing instrument body portion having: at one end side thereof, a writing unit that writes down on a medium on which a code image is formed; a light emitting unit that emits light to the medium; and an image capture unit that captures an image from reflected light reflected on the medium by the emitting light, and the detachable cap being detachably attached to the one end side of the electronic writing instrument body portion, the electronic writing method comprising:
capturing the code image formed on the medium based on the reflected light; and
covering the writing unit of the electronic writing instrument body portion and passing the emitted light emitted from the light emitting unit and the reflected light reflected on the medium when the detachable cap is attached to the one end side of the electronic writing instrument body portion.
